(19) United States
(12) Patent Application Publication
(10) Pub. No.: US 2026/0286151 A1
(43) Pub. Date: Sep. 24, 2026

(54) CERAMIC SLURRY COMPOSITIONS

(71) Applicant: Dow Global Technologies LLC, Midland, MI (US)

(72) Inventors: Peng Gao, Shanghai (CN); Meijia He, Shanghai (CN)

(21) Appl. No.: 19/477,534

(22) PCT Filed: May 26, 2023
(86) PCT No.: PCT/CN2023/096455

§ 371 Date: Oct. 22, 2025

(51) Int. Cl. C09D 7/65; C09D 7/40; C09D 7/61; C09D 109/06

(52) U.S. Cl. CPC C09D 7/65; C09D 7/61; C09D 7/68; C09D 109/06

(57) ABSTRACT

A ceramic slurry includes water, a plurality of ceramic particles, a binder, lithium hydroxide, and a rheology modifier. The rheology modifier includes 30 wt % to 70 wt % of units derived from ethyl acrylate based on a total weight of the rheology modifier; 20 wt % to 60 wt % of units derived from meth acrylic acid based on a total weight the rheology modifier; and 1 wt % to 20 wt % of units derived from a functional monomer based on a total the rheology modifier. The functional monomer has Structure (I) where m has an average value from 10 to 40 and n has an average value from 5 to 30.

### BACKGROUND

### Field of the Invention

The present disclosure generally relates to slurry compositions, and more specifically to ceramic slurry compositions for use in battery separators.

### INTRODUCTION

Lithium-ion batteries (“LIBs”) offer a variety of advantages over traditional battery types such as high energy density, a high operating voltage and long cycle life. These advantages mean LIBs are widely used as a power supply for various mobile devices and electric vehicles. One of the key components of LIBs is a separator. The separator is typically made of a polyolefin based porous membrane that comprises high density polyethylene. The separator serves the function of separating the cathode from the anode to avoid the short circuit of the battery while permitting the passage of lithium ions during charging and discharging of the battery. After many charge and discharge cycles, lithium dendrites may form which can puncture the separator and initiate thermal runaway. As a result, almost all separators used in LIBs are coated by a ceramic coating to provide resistance to lithium dendrites.

Traditionally, the ceramic coated separator is produced by applying a ceramic slurry to a separator followed by a drying step in an oven. The composition of the ceramic slurry contains ceramic nanoparticles, usually Al₂O₃, a polymer binder, a rheology modifier and a dispersant. Among these ingredients, the binder is usually polymer emulsions of polybutylacrylate or styrene-butadiene rubber with the rheology modifier being carboxymethyl cellulose (“CMC”) that it neutralized with sodium (i.e., a salt). A ceramic coating needs to meet an adhesion to the separator of 30 newtons per meter (“N/m”) or greater as measured by an Adhesion Test as further described below. The ceramic coating also must exhibit a shrinkage of 5% or less as measured according to a Thermal Shrinkage Test as further described below.

Ceramic coatings for LIBs have faced several issues over the years. First, the sodium used in the CMC is considered a metal impurity in LIBs. Metal impurities have a lower reduction potential than lithium ions and as a result will be embedded in the graphite anode thereby reducing the insertion position of lithium ions. The embedding of the metal impurities results in reducing the reversible capacity of LIBs. Second, while the CMC sodium salt is water dispersible, the chemical and physical structure of the CMC can lead to prolonged dissolving times in water. For example, in battery manufacturing it may take up to four hours to completely dissolve the CMC sodium salt to form a transparent solution that may be used in the ceramic slurry.

In view of the foregoing, it would be surprising to discover a ceramic slurry that not only produces a ceramic coating with an adhesion to the separator of 30 N/m or greater as measured by an Adhesion Test and a shrinkage of 5% or less as measured according to a Thermal Shrinkage Test, but also reduces the associated manufacturing time and eliminates metal impurities from the ceramic coating.

### SUMMARY OF THE DISCLOSURE

The inventors of the present disclosure have surprisingly discovered a ceramic slurry that not only produces a ceramic coating with an adhesion to the separator of 30 N/m or greater as measured by the Adhesion Test and a shrinkage of 5% or less as measured according to the Thermal Shrinkage Test, but also reduces the associated manufacturing time and eliminates metal impurities from the ceramic coating.

The present invention is the result of discovering that by utilizing a polymeric emulsion comprising hydrophobically modified alkali swellable emulsions (“HASE”) as the rheology modifier of the ceramic slurry, the above-noted properties may be achieved. Without being bound by theory, it is believed that the nanosized particles of the polymeric emulsion, along with the increase in pH provided by the addition of lithium hydroxide, renders the polymeric emulsion readily water soluble and therefore decreases the manufacturing time associated with its use. Further, by using lithium hydroxide, metal impurities are avoided. When used in the ceramic slurry, the polymeric emulsion is able to provide a resulting ceramic coating on separators for LIBs that meets the target adhesion and shrinkage values.

According to a first feature of the present disclosure, a ceramic slurry, comprises water; a plurality of ceramic particles, a binder, lithium hydroxide, and a rheology modifier. The rheology modifier comprises 30 wt % to 70 wt % of units derived from ethyl acrylate based on a total weight of the rheology modifier, 20 wt % to 60 wt % of units derived from meth acrylic acid based on a total weight the rheology modifier, and 1 wt % to 20 wt % of units derived from a functional monomer based on a total the rheology modifier, wherein the functional monomer has Structure (I) wherein m has an average value from 10 to 40 and n has an average value from 5 to 30.

According to a second feature of the present disclosure, the ceramic slurry comprises from 40 wt % to 65 wt % water based on the total weight of the ceramic slurry.

According to a third feature of the present disclosure, the plurality of ceramic particles comprises Al₂O₃ and the ceramic particle exhibit a D₅₀ particle diameter of 1000 nanometers or less.

According to a fourth feature of the present disclosure, the binder comprises one or more of polybutylacrylate and styrene-butadiene rubber.

According to a fifth feature of the present disclosure, the ceramic slurry comprises from 0.1 wt % to 7 wt % of the binder based on the total weight of the ceramic slurry.

According to a sixth feature of the present disclosure, the ceramic slurry comprises from 0.01 wt % to 1 wt % of the rheology modifier based on the total weight of the ceramic slurry.

According to a seventh feature of the present disclosure, the ceramic slurry comprises from 0.05 wt % to 0.2 wt % of the rheology modifier based on the total weight of the ceramic slurry.

According to an eighth feature of the present disclosure, wherein the rheology modifier comprises 45 wt % to 55 wt % of ethyl acrylate based on a total weight of the rheology modifier, 35 wt % to 45 wt % of meth acrylic acid based on a total weight of the rheology modifier, and 5 wt % to 10 wt % of the functional monomer based on a total weight of the rheology modifier.

According to a ninth feature of the present disclosure, n of Structure (I) has an average value of 10 to 20.

According to a tenth feature of the present disclosure, m of Structure (I) has an average value of 20 to 25.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, the term weight percent (“wt %”) designates the percentage by weight a component is of a total weight of an indicated composition.

As used herein, the term “solids” refers to the wt. % in compositions of solids of the primary polyolefin dispersions, the second film forming dispersion, dispersants and stabilizing agents and, when present, pigments, fillers or extenders and any additives that are not volatile under use conditions for the compositions of the present invention. For example, water, additives such as coalescents and solvents or bases, like ammonia or lower alkyl amines that volatilize under use conditions of the compositions of the present invention are not considered solids.

### Ceramic Slurry

The present disclosure is directed to ceramic slurries, and more specifically to waterborne ceramic slurries. The slurry comprises water, a plurality of ceramic particles, a binder, a rheology modifier, and lithium hydroxide. The ceramic slurry may comprise 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, while at the same time, 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less of the water based on the total weight of the ceramic slurry.

### Ceramic Particles

The ceramic slurry comprises a plurality of ceramic particles. The ceramic slurry may comprise from 20 wt % to 60 wt %, or from 30 wt % to 50 wt %, or from 35 wt % to 45 wt % of the ceramic particles based on a total weight of the ceramic slurry. For example, the ceramic slurry may comprise 20 wt % or greater, or 22 wt % or greater, or 24 wt % or greater, or 26 wt % or greater, or 28 wt % or greater, or 30 wt % or greater, or 32 wt % or greater, or 34 wt % or greater, or 36 wt % or greater, or 38 wt % or greater, or 40 wt % or greater, or 42 wt % or greater, or 44 wt % or greater, or 46 wt % or greater, or 48 wt % or greater, or 50 wt % or greater, or 52 wt % or greater, or 54 wt % or greater, or 56 wt % or greater, or 58 wt % or greater, while at the same time, 60 wt % or less, or 58 wt % or less, or 56 wt % or less, or 54 wt % or less, or 52 wt % or less, or 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less of the ceramic particles based on the total weight of the ceramic slurry.

The ceramic particles of the ceramic slurry may exhibit a D₅₀ particle size of 1000 nanometers (“nm”) or less as measured by dynamic light scattering using a Malvern ZETASIZER™ ZEN3600 series particle size analyzer. For example, the ceramic particles may have a D₅₀ particle size of 1000 nm or less, or 950 nm or less, or 900 nm or less, or 850 nm or less, or 800 nm or less, or 750 nm or less, or 700 nm or less, or 650 nm or less, or 600 nm or less, or 550 nm or less, or 500 nm or less, or 450 nm or less, or 400 nm or less, or 350 nm or less, or 300 nm or less, or 250 nm or less, or 200 nm or less, or 150 nm or less, or 100 nm or less, while at the same time, 50 nm or greater, or 100 nm or greater, or 200 nm or greater, or 300 nm or greater, or 400 nm or greater, or 500 nm or greater, or 600 nm or greater, or 700 nm or greater, or 800 nm or greater, or 900 nm or greater.

The composition of the ceramic particles may be a single material type or multiple material types. For example, the composition of the ceramic particles is selected from the group consisting of alumina (Al₂O₃), zirconia, silica and hydroxyapatite. It will be understood that the ceramic particles either in aggregate, or singularly, may comprise different ceramic types and different phases of the same ceramic.

### Binder

The ceramic slurry comprises the binder. The binder aids in binding or holding the ceramic particles together once they are deposited on a separator and after the slurry has been dried to form the ceramic coating. The binder may comprise one or more of polybutylacrylate butylacrylate-methylmethacrylate copolymer, acrylonitrile-butylacrylate copolymer, acrylonitrile-acrylamide-butylacrylate copolymer, and styrene-butadiene rubber.

The ceramic slurry may comprise from 0.1 wt % to 7 wt % of the binder based on the total weight of the ceramic slurry. For example, the ceramic slurry may comprise 0.1 wt % or greater, or 0.5 wt % or greater, or 1 wt % or greater, or 2 wt % or greater, or 3 wt % or greater, or 4 wt % or greater, or 5 wt % or greater, or 6 wt % or greater, while at the same time, 7 wt % or less, or 6 wt % or less, or 5 wt % or less, or 4 wt % or less, or 3 wt % or less, or 2 wt % or less, or 1 wt % or less, or 0.5 wt % or less of the binder based on the total weight of the ceramic slurry.

The binder may be added to the ceramic slurry a solid or as an emulsion. In examples where the binder is an emulsion, the binder emulsion may be from 20 wt % to 60 wt % solids based on the total weight of the binder emulsion. For example, the binder emulsion may be 20 wt % or greater, or 25 wt % or greater, or 30 wt % or greater, or 35 wt % or greater, or 40 wt % or greater, or 45 wt % or greater, or 50 wt % or greater, or 55 wt % or greater, while at the same time, 60 wt % or less, or 55 wt % or less, or 50 wt % or less, or 45 wt % or less, or 40 wt % or less, or 35 wt % or less, or 30 wt % or less, or 25 wt % or less based on a total weight of the binder emulsion. In examples where the binder is added as a binder emulsion to the ceramic slurry, the ceramic slurry may comprise from 1 wt % to 10 wt % of the binder emulsion based on the total weight of the ceramic slurry. For example, the ceramic slurry may comprise 1 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, while at the same time, 10 wt % or less, or 9 wt % or less, or 8 wt % or less, or 7 wt % or less, or 6 wt % or less, or 5 wt % or less, or 4 wt % or less, or 3 wt % or less, or 2 wt % or less of the binder emulsion based on the total weight of the ceramic slurry. The binder emulsion may be from 1 wt % to 80 wt % solids.

### Rheology Modifier

The ceramic slurry comprises the rheology modifier. In operation, the rheology modifier functions to thicken the ceramic slurry such that it can be applied, and adhere well, to the battery separator. The ceramic slurry may comprise from 0.01 wt % to 1.00 wt % of the rheology modifier based on the total weight of the ceramic slurry. For example, the ceramic slurry may comprise 0.01 wt % or greater, or 0.05 wt % or greater, or 0.10 wt % or greater, or 0.15 wt % or greater, or 0.20 wt % or greater, or 0.25 wt % or greater, or 0.30 wt % or greater, or 0.35 wt % or greater, or 0.40 wt % or greater, or 0.45 wt % or greater, or 0.50 wt % or greater, or 0.55 wt % or greater, or 0.60 wt % or greater, or 0.65 wt % or greater, or 0.70 wt % or greater, or 0.75 wt % or greater, or 0.80 wt % or greater, or 0.85 wt % or greater, or 0.90 wt % or greater, or 0.95 wt % or greater, while at the same time, 1.00 wt % or less, or 0.95 wt % or less, or 0.90 wt % or less, or 0.85 wt % or less, or 0.80 wt % or less, or 0.75 wt % or less, or 0.70 wt % or less, or 0.65 wt % or less, or 0.60 wt % or less, or 0.55 wt % or less, or 0.50 wt % or less, or 0.45 wt % or less, or 0.40 wt % or less, or 0.35 wt % or less, or 0.30 wt % or less, or 0.25 wt % or less, or 0.20 wt % or less, or 0.15 wt % or less, or 0.10 wt % or less, or 0.05 wt % or less of the rheology modifier based on the total weight of the ceramic slurry.

The rheology modifier is a copolymer of units derived from ethyl acrylate, meth acrylic acid and a functional monomer. The rheology modifier may be a random copolymer or a block copolymer. The rheology modifier may be added to the ceramic slurry as a dispersion of the rheology modifier in one or more fluids (e.g., water). The rheology modifier may be from 5 wt % to 50 wt % solids based on the total weight of the rheology modifier. For example, the rheology modifier may be may be 5 wt % or greater, or 10 wt % or greater, or 15 wt % or greater, 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less, or 20 wt % or less, or 15 wt % or less, or 10 wt % or less solids based on a total weight of the rheology modifier.

The rheology modifier comprises from 30 wt % to 70 wt % of units derived from ethyl acrylate based on a total weight of the rheology modifier. For example, the rheology modifier may be may be 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less ethyl acrylate based on a total weight of the rheology modifier.

The rheology modifier comprises from 20 wt % to 60 wt % of units derived from meth acrylic acid based on a total weight of the rheology modifier. For example, the rheology modifier may be may be 20 wt % or greater, or 25 wt % or greater, or 30 wt % or greater, or 35 wt % or greater, or 40 wt % or greater, or 45 wt % or greater, or 50 wt % or greater, or 55 wt % or greater, while at the same time, 60 wt % or less, or 55 wt % or less, or 50 wt % or less, or 45 wt % or less, or 40 wt % or less, or 35 wt % or less, or 30 wt % or less, or 25 wt % or less of units derived from meth acrylic acid based on a total weight of the rheology modifier.

The rheology modifier comprises units derived from the functional monomer. The functional monomer has Structure (I)

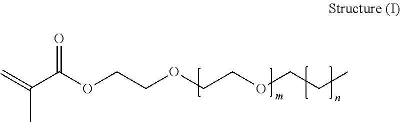

wherein m is an average value from 10 to 40 and n has an average value from 5 to 30. The m and n values of Structure (I) are determined using ¹³C Nuclear Magnetic Resonance. The m of Structure (I) may have an average value of 10 or greater, or 12 or greater, or 14 or greater, or 16 or greater, or 18 or greater, or 20 or greater, or 22 or greater, or 24 or greater, or 26 or greater, or 28 or greater, or 30 or greater, or 32 or greater, or 34 or greater, or 36 or greater, or 38 or greater, while at the same time, 40 or less, or 38 or less, or 36 or less, or 34 or less, or 32 or less, or 30 or less, or 28 or less, or 26 or less, or 24 or less, or 22 or less, or 20 or less, or 18 or less, or 16 or less, or 14 or less, or 12 or less. The n of Structure (I) may have an average value of 5 or greater, or 6 or greater, or 8 or greater, or 10 or greater, or 12 or greater, or 14 or greater, or 16 or greater, or 18 or greater, or 20 or greater, or 22 or greater, or 24 or greater, or 26 or greater, or 28 or greater, while at the same time, 30 or less, or 28 or less, or 26 or less, or 24 or less, or 22 or less, or 20 or less, or 18 or less, or 16 or less, or 14 or less, or 12 or less, or 10 or less, or 8 or less, or 6 or less.

The rheology modifier may comprise from 1 wt % to 20 wt % of the functional monomer based on the total weight of the rheology modifier. For example, rheology modifier may comprise 1 wt % or greater, or 2 wt % or greater, or 4 wt % or greater, or 6 wt % or greater, or 8 wt % or greater, or 10 wt % or greater, or 12 wt % or greater, or 14 wt % or greater, or 16 wt % or greater, or 18 wt % or greater, while at the same time, 20 wt % or less, or 18 wt % or less, or 16 wt % or less, or 14 wt % or less, or 12 wt % or less, or 10 wt % or less, or 8 wt % or less, or 6 wt % or less, or 4 wt % or less, or 2 wt % or less of the functional monomer based on the total weight of the rheology modifier.

The rheology modifier may be added to the ceramic slurry as a rheology modifier solution with the rheology modifier dissolved in a solvent to form a rheology modifier solution. The solvent in which the rheology modifier is dissolved may be water or another solvent. Lithium hydroxide may be added to the rheology modifier solution to bring the pH of the solution to a desired value. The pH of the rheology modifier solution may be 7.0 or greater, or 7.2 or greater, or 7.4 or greater, or 7.6 or greater, or 7.8 or greater, or 8.0 or greater, or 8.1 or greater, or 8.2 or greater, or 8.4 or greater, or 8.6 or greater or 8.8 or greater, while at the same time, 9.0 or less, or 8.8 or less, or 8.6 or less, or 8.4 or less, or 8.2 or less, or 8.0 or less, or 7.8 or less, or 7.6 or less, or 7.4 or less, or 7.2 or less.

### Additives

The ceramic slurry may comprise one or more additive or auxiliary polymer, such as one or more of an acrylic emulsion polymer, vinyl acrylic emulsion polymer, styrene acrylic emulsion polymer, vinyl acetate ethylene emulsion polymer, and combinations thereof; one or more fillers; one or more additives such as catalysts, wetting agents, defoamers, flow agents, release agents, slip agents, anti-blocking agents, additives to mask sulfur staining, pigment wetting/dispersion agents, anti-settling agents, one or more co-solvents, e.g., glycols, glycol ether, 2,2,4-trimethyl-1,3-pentanediol monoisobutyrate, alcohols, mineral spirits, aromatic solvents and benzoate esters or the like; one or more dispersants, e.g., aminoalcohols, and polycarboxylates; one or more surfactants; one or more preservatives, e.g., biocides, mildewcides, fungicides, algaecides, and combinations thereof; or one or more additional neutralizing agents, e.g., hydroxides, amines, ammonia, and carbonates; optionally one or more solvents or coalescing agents. In a specific example, the ceramic slurry may comprise a highly branched secondary alcohol ethoxylate surfactant in an amount ranging from 0.1 wt % to 1 wt %, or from 0.2 wt % to 0.8 wt %, or from 0.3 wt % to 0.5 wt % based on the total weight of the ceramic slurry. A commercial example of a highly branched secondary alcohol ethoxylate surfactant is TRITON™ HW-1000 from The Dow Chemical Company, Midland Michigan. In another specific example, the ceramic slurry may comprise a highly branched secondary alcohol ethoxylate surfactant in an amount ranging from 0.05 wt % to 1 wt %, or from 0.1 wt % to 0.5 wt %, or from 0.15 wt % to 0.3 wt % based on the total weight of the ceramic slurry.

### EXAMPLES

### Materials

The following materials were used in the formation of the comparative examples (“CE”) and the inventive examples (“IE”).

LiOH is analytical grade lithium hydroxide monohydrate which is available from Sinopharm Chemical Reagent Co., Shanghai, China.

SBR is styrene-butadiene-rubber latex binder which is commercially available as BM-451B Zeon Corp. Tokyo, Japan.

Ceramic is Al2O3 powder having a D50 of approximately 300 to 1000 nm and is commercially available as ZC-L01 from Zhongchao company, Luoyang City, China.

DISP is polyacrylic acid dispersant having a weight average molecular weight of around 60,000 g/mol and is commercially available from The Dow Chemical Company, Midland, Michigan, USA.

Copolymer 1 is an EA, MAA and functional monomer copolymer comprising 49.9 wt % EA, 39.9 wt % MAA and 10.2 wt % of Structure (I) where m has an average value of 20 and n has an average value of 16 to 18. Copolymer 1 was synthesized by an emulsion polymerization process. Specifically, the monomers and initiator (potassium persulfate) are gradually added into a water-surfactant solution in a preheated flask. The contents of the flask are stirred and maintained at a temperature around 80° C. After all ingredients are added, stirring and the elevated temperature are for 2 hours to produce the final emulsion of Copolymer 1.

Copolymer 2 is an EA, MAA and functional monomer copolymer comprising 50.3 wt % EA, 44.8 wt % MAA, 3.5 wt % of Structure (I) where m has an average value of 20 and n has an average value of 16 to 18 and 1.4 wt % of Structure (I) where m has an average value of 20 and n has an average value of 12 to 14. Copolymer 2 was synthesized by an emulsion polymerization process. Specifically, the monomers and initiator (potassium persulfate) are gradually added into a water-surfactant solution in a preheated flask. The contents of the flask are stirred and maintained at a temperature around 80° C. After all ingredients are added, stirring and the elevated temperature are for 2 hours to produce the final emulsion of Copolymer 2.

WA is a highly branched wetting agent commercially available as TRITON™ HW-1000 from The Dow Chemical Company, Midland, Michigan, USA.

CMC is carboxymethyl cellulose that it neutralized with sodium and is commercially available as CMC-Na 1220 from Diacel Corp., Osaka, Japan.

HDPE is a 12 μm thick high density polyethylene separator available from Shenzhen Xingyuan Separator Company, Shenzhen City, Guangdong province, China.

Water is deionized water.

### Test Methods

Thermal shrinkage Test: The thermal shrinkage was carried out on the prepared separator samples and measured the dimensional changes after storage at 130° C. for 1 hour and in accordance with standard test method GB/T 34848. Samples with dimensions of 10 cm×20 cm were prepared for this test. The change in dimensions were calculated using the following equation: Shrinkage %=(Wi−Wf)/Wi×100, where Wi is the initial length and Wf is the final length of the separator after the storage test.

Adhesion Test Following ASTM D903, sample coatings were covered by Flatback Masking Tape 250 from 3M company and peeled off from the separator at a 180 degree and 10 cm/minute rate using an Instron™ 5566 tensile testing instrument. The steady force was recorded and at least 3 specimens were tested to report an average value.

Ceramic slurry viscosity was measured using Brookfield Viscometer DV-II+ Pro equipped with a #2 spindle at 60 revolutions per minute (“rpm”) at 23° C. The viscosity measurements are provided in centipoise (“cP”).

### Sample Preparation

Dissolution Sample Preparation: Rheology modifier samples were prepared by adding 2 grams of the indicated material and 98 grams of water to a mixing vessel to form a rheology modifier mixture. The mixture was then mixed using an IKA Eurostar™ 60 Digital Mixer at 500 rpm until the mixture was transparent. Next, a LiOH aqueous solution (5 g LiOH and 95 g water) was added to the solution for IE1 and IE2 and was stirred several minutes to get a totally uniform, white emulsion. Stirring was then stopped and the time the emulsion took to turn from white to transparent and uniform was recorded.

Preparation of Ceramic Slurry: The ceramic powder and water were added into mixing jar and capped and mixed at 2000 rpm in a FlackTek, DAC 150.1 FVZ speed mixer for 2 minutes. The DISP polyacrylic acid dispersant was then added and the mixture was mixed at 2000 rpm for an additional 2 minutes. Next, the SBR, indicated rheology modifier and the WE wetting agent were added and were mixed at 2000 rpm for 2 minutes or until a uniform white slurry was obtained.

Preparation of Ceramic Coating on Separator: Once the ceramic slurry was made, the slurry was manually applied on HDPE separator using an HKC-3 rod bar (which applies an approximately 24 μm slurry layer which generates around 3~4 μm ceramic coating layer). Right after the slurry coating was applied, the separator sample was transferred to a 50° C. oven for drying for 5 minutes.

### Results

Table 1 provides the test results for the dissolution samples. Specifically, Table 1 provides the time each material took to dissolve into the water and form a transparent, uniform, and viscous rheology modifier solution.

TABLE 1

| Sample | CE1 | IE1 | IE2 |
|---|---|---|---|
| Material | CMC | Copolymer1 | Copolymer2 |
| Material concentration in | 2% | 2% | 2% |
| rheology modifier solution | | | |
| pH of solution after | (Does not | 8.1 | 8.2 |
| neutralized by LiOH | need LiOH) | | |
| Dissolving time (second) | 1020 | 17 | 23 |

As can be seen from Table 1, the use of Copolymer1 and Copolymer2 drastically decrease the time required for a uniform solution to be formed as compared to the CMC of CE1. The CMC based rheology modifier tends to absorb water to form a viscous gel which hinders further water adsorption by the core of the CMC powder resulting in very long time for water to dilute the gel into less viscous solution and further penetrate the core of CMC powder. Unlike the CMC, the rheology modifier materials of IE1 and IE1 contains MAA unit which reacts with LiOH and renders the whole polymer water soluble thereby increasing the dissolution time. As explained above, the drastic decrease of time required to make the rheology modifier solution has substantial manufacturing benefits compared to the traditional CMC usage. Additionally, removal of sodium metal impurities aid in the life of the battery.

Table 2 provides both the composition of the samples, but also the mechanical properties of the ceramic coatings formed from the ceramic slurries. For clarity, the water weight reported in Table 2 is the weight of the water present in the rheology modifier suspending the solids.

TABLE 2

| | Sample | | | | | |
|---|---|---|---|---|---|---|
| | CE2 | IE3 | IE4 | IE5 | IE6 | IE7 |
| Ceramic | 40.6 | 40.6 | 40.6 | 40.6 | 40.6 | 40.6 |
| weight (g) | | | | | | |
| Dispersant | 0.15 | 0.15 | 0.15 | 0.15 | 0.15 | 0.15 |
| weight (g) | | | | | | |
| Rheology | CMC | IE1 | IE1 | IE1 | IE2 | IE2 |
| modifier | | | | | | |
| Rheology | 0.28 | 0.15 | 0.11 | 0.19 | 0.07 | 0.10 |
| modifier solids | | | | | | |
| weight (g) | | | | | | |
| Binder (g) | 4.88 | 4.88 | 4.91 | 4.83 | 4.97 | 4.79 |
| WA (g) | 0.40 | 0.40 | 0.38 | 0.37 | 0.39 | 0.40 |
| Water (g) | 53.69 | 53.82 | 53.85 | 53.86 | 53.82 | 53.96 |
| Total | 100 | 100 | 100 | 100 | 100 | 100 |
| weight (g) | | | | | | |

Ceramic coating properties

| | | | | | | |
|---|---|---|---|---|---|---|
| Brookfield | 65 | 66 | 43 | 86 | 51 | 72 |
| viscosity (cP) | | | | | | |
| Shrinkage (%) | 3.17 | 2.83 | 3.20 | 2.23 | 3.10 | 3.03 |
| Shrinkage | 0.29 | 0.52 | 0.45 | 0.14 | 0.34 | 0.75 |
| (Stdev) | | | | | | |
| Adhesion | 48.6 | 37.6 | 34.1 | 49.8 | 35.7 | 43.5 |
| (N/m) | | | | | | |
| Adhesion | 18.2 | 4.8 | 7.9 | 15.3 | 13.3 | 12.6 |
| (Stdev) | | | | | | |

Referring now to Table 2, IE3-IE7 each had a higher viscosity than 30 cP, which enabled ceramic slurry stability and continuous coating application. Additionally, the adhesion performance of IE3-IE7 was comparable to CE2 while all adhesion values being above the minimum required 30 N/m. The ceramic coatings also demonstrated comparable or improved (i.e., lower) shrinkage values than CE2. For example, IE4, IE6 and IE7 are comparable to CE2, while IE3 and IE5 provide reduced shrinkage as compared to CE2.

From the foregoing, it is clear that ceramic slurries comprising water, a plurality of ceramic particles; a binder emulsion, lithium hydroxide and a polymeric emulsion as laid out above are able to not only recued manufacturing time associated with ceramic slurries and ceramic coatings, but also eliminate sodium contamination and provide the same or better mechanical properties.

What is claimed is:

1. A ceramic slurry, comprising:
water;
a plurality of ceramic particles;
a binder;
lithium hydroxide; and
a rheology modifier comprising:
30 wt % to 70 wt % of units derived from ethyl acrylate based on a total weight of the rheology modifier;
20 wt % to 60 wt % of units derived from meth acrylic acid based on a total weight the rheology modifier; and
1 wt % to 20 wt % of units derived from a functional monomer based on a total the rheology modifier, wherein the functional monomer has Structure (I) 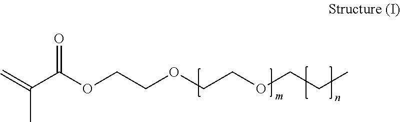
wherein m has an average value from 10 to 40 and n has an average value from 5 to 30.

2. The ceramic slurry of claim 1, wherein the ceramic slurry comprises from 40 wt % to 65 wt % water based on the total weight of the ceramic slurry.

3. The ceramic slurry of claim 1, wherein the plurality of ceramic particles comprises Al₂O₃ and the ceramic particle exhibit a D₅₀ particle diameter of 1000 nanometers or less.

4. The ceramic slurry of claim 1, wherein the binder comprises one or more of polybutylacrylate and styrene-butadiene rubber.

5. The ceramic slurry of claim 1, wherein the ceramic slurry comprises from 0.1 wt % to 7 wt % of the binder based on the total weight of the ceramic slurry.

6. The ceramic slurry of claim 1, wherein the ceramic slurry comprises from 0.01 wt % to 1 wt % of the rheology modifier based on the total weight of the ceramic slurry.

7. The ceramic slurry of claim 1, wherein the ceramic slurry comprises from 0.05 wt % to 0.2 wt % of the rheology modifier based on the total weight of the ceramic slurry.

8. The ceramic slurry of claim 1, wherein the rheology modifier comprises:
45 wt % to 55 wt % of ethyl acrylate based on a total weight of the rheology modifier;
35 wt % to 45 wt % of meth acrylic acid based on a total weight of the rheology modifier; and
5 wt % to 10 wt % of the functional monomer based on a total weight of the rheology modifier.

9. The ceramic slurry of claim 1, wherein n of Structure (I) has an average value of 10 to 20.

10. The ceramic slurry of claim 1, wherein m of Structure (I) has an average value of 20 to 25.
